(19) United States
(12) Patent Application Publication
(10) Pub. No.: US 2018/0285596 A1
(43) Pub. Date: Oct. 4, 2018

(54) SYSTEM AND METHOD FOR MANAGING SENSITIVE DATA

(71) Applicant: CISCO TECHNOLOGY, INC., San Jose, CA (US)

(72) Inventors: Von Jones, Sugar Land, TX (US); Jai Mathaiyan, Austin, TX (US); Devarajan Sundararajan, San Ramon, CA (US); Nirmalya Sen, San Jose, CA (US)

(21) Appl. No.: 15/474,502

(22) Filed: Mar. 30, 2017

(51) Int. Cl. G06F 21/62; G06F 21/60

(52) U.S. Cl. CPC G06F 21/6254; G06F 21/602

(57) ABSTRACT

The disclosed technology relates to managing sensitive information in a network environment. A system is configured to receive first data from a plurality of network entities, identify information relating to the identity of the network entities contained in the first data, extract information identifying the network entities from the first data, store the information identifying the network entities in a first data store, replace the information identifying the network entities in the first data with one or more identifiers to create second data, and storing the second data in a second data store. The system is further configured to locate and retrieve the information identifying the network entities in the first data store using one or more corresponding identifiers.

### TECHNICAL FIELD

The present disclosure relates generally to data management, and more particularly, to managing sensitive data in a network environment.

### BACKGROUND

A managed network, such as an enterprise private network (EPN), may contain a large number of network entities distributed across the network. These entities include, for example, nodes, endpoints, machines, virtual machines, containers (an instance of container-based virtualization), and applications. In addition to being different types, these entities may be grouped in different departments, located in different geographical locations, and/or serve different functions.

An expansive or thorough understanding of the network can be critical for network management tasks such as anomaly detection (e.g., network attacks and misconfiguration), network security (e.g., preventing network breaches and reducing network vulnerabilities), asset management (e.g., monitoring, capacity planning, consolidation, migration, and continuity planning), and compliance (e.g. conformance with governmental regulations, industry standards, and corporate policies). Management of networks conventionally requires knowledge of information about devices connected to the network. Such information may include information that is considered sensitive due to the likelihood that such information reveals information about a particular client or customer. Sensitive information may include, for example, client server names, host names, IP addresses, application names, or any data that reveals internal information about a customer or client and their network environment.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a conceptual block diagram illustrating an example network environment utilizing a management platform, in accordance with various embodiments of the subject technology.

FIG. 2 is a conceptual block diagram illustrating example data stored in data stores, in accordance with various embodiments of the subject technology.

FIG. 3 depicts an example method for managing sensitive data in a network environment, in accordance with various aspects of the subject technology.

FIGS. 4A and 4B illustrate examples of systems in accordance with some embodiments.

### DESCRIPTION OF EXAMPLE EMBODIMENTS

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

Management of networks conventionally requires knowledge of information about devices connected to the network. The information is typically transmitted across the network to network-based management or monitoring applications for analysis, development of metrics, and/or failure prediction. Such information may include information that is considered sensitive due to the likelihood that such information reveals information about a particular client or customer. Sensitive information may include, for example, client server names, host names, IP addresses, application names, or any data that reveals internal information about a customer or client and their network environment, as well as information that is traditionally considered sensitive such as names, phone numbers, addresses, social security numbers, personal identification numbers, identification numbers, or other personal identification information that may be used in certain applications and stored by a management platform system. Transmitting sensitive information across the network naturally increases the likelihood that the sensitive information may become compromised or otherwise inadvertently disclosed.

The disclosed technology addresses the need in the art for securing sensitive network information used to manage or monitor network environments. For example, a collector module may be utilized to review and identify information that may be considered sensitive to isolate and extract the sensitive information for storage in a secure and encrypted database. Information that is not considered sensitive may be stored in a conventional database for analysis and processing, as desired. Reinsertion of the sensitive information may be accomplished by use of one or more identifiers that are inserted in place of the sensitive information. The identifier may facilitate later retrieval of the sensitive information by having a letters, codes or numbers assigned to the sensitive information. The identifier may further include information identifying the type of information the sensitive information represents. For example, if the sensitive information represents a client server name, the identifier may have a prefix indicating that the removed or scrubbed sensitive information represents a client server name. The identifier may thus serve two purposes, the first being to locate the sensitive information in the secured database, and the second to indicate the type of information removed.

Further, by removing sensitive information from the data and storing non-sensitive information in the conventional database, analysis of the data stored in the conventional database may be performed more efficiently due to not only the reduced size of the data being stored in the conventional database, but also due to analysis and querying of data not requiring encryption and decryption. Because the conventional database does not contain sensitive information, there is no need to encrypt the data stored in the conventional database.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

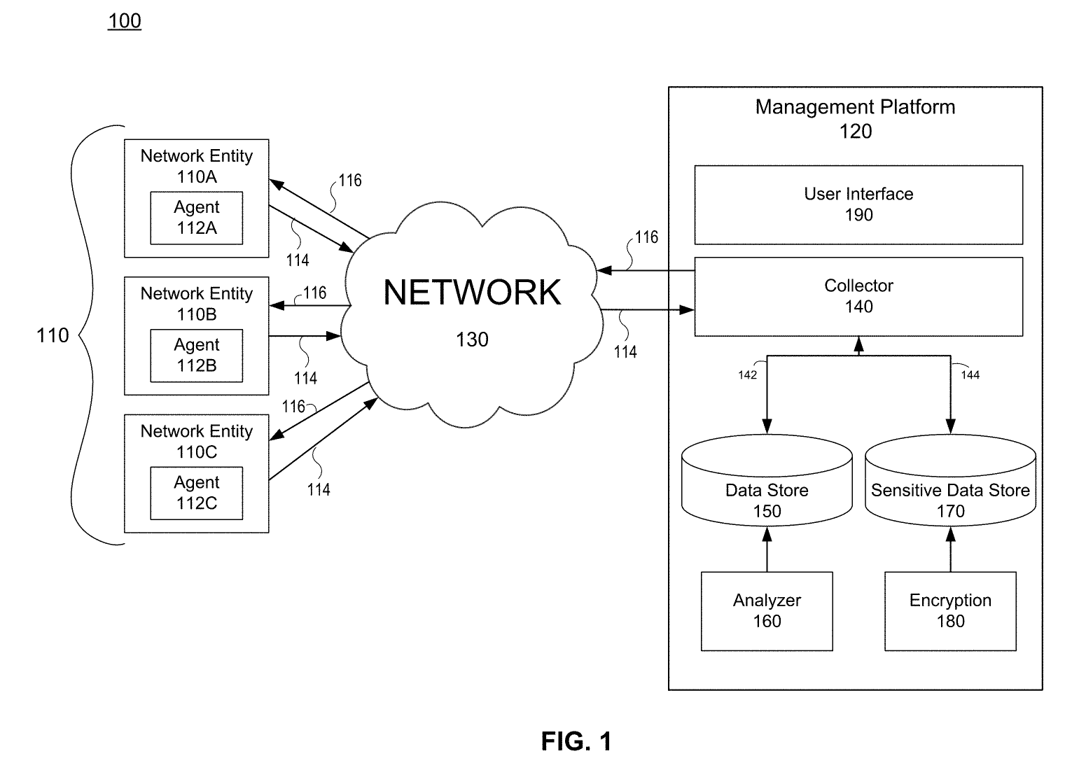

FIG. 1 illustrates a conceptual block diagram illustrating an example network environment 100 utilizing a management platform 120, in accordance with various embodiments of the subject technology. Various embodiments are discussed with respect to a general wide area network 130 for illustrative purposes, however, these embodiments and others may be applied to other types of networks. For example, the network environment 100 may be implemented by any type of network 130 and may include, for example, any one or more of an enterprise private network (EPN), cellular network, a satellite network, a personal area network (PAN), a local area network (LAN), a broadband network (BBN), the Internet, and the like. The network 130 in the network environment 100 can be a public network, a private network, or a combination thereof. The network environment 100 may be implemented using any number of communications links associated with one or more service providers, including one or more wired communication links, one or more wireless communication links, or any combination thereof. Additionally, the network environment 100 can be configured to support the transmission of data formatted using any number of protocols.

The network environment 100 includes one or more network entities 110, with each network entity 110A-C having a respective agent 112A-C. The network entities 110 may include machines (e.g., servers, personal computers, laptops), virtual machines, applications, containers, mobile devices (e.g., tablets or smart phones), smart devices (e.g., set top boxes, smart appliances, smart televisions, internet-of-things devices), or network equipment, servers, containers, among other computing devices. Each agent 112A-C is configured to communicate with the management platform 120 via a collector module 140. The management platform 120 includes the collector module 140, a user interface module 190, a data store 150, an analyzer module 160, a sensitive data store 170 and an encryption module 180. In other embodiments, the management platform 120 may include additional components, fewer components, or alternative components. The management platform 120 may be implemented as a single machine or distributed across a number of machines in the network, and may comprise one or more servers.

Each agent 112A-C may be installed on a respective network entity 110A-C and configured to transmit data to and receive data from (e.g., network entity information, application information, performance information, event information) the network management platform 120 via the collector module 140. After an initial installation on a network entity 110 (e.g., a machine, virtual machine, or container, etc.), each agent 112 may be configured to register with the management platform 110, observe and collect data, and report the collected data to the management platform 120 via the network 130. The agent 112 may collect performance related data associated with the network entity 110, such as events, logs, metrics, transactions, alerts, time-based data, or other telemetry records. The agent 112 may further be configured to collect performance data relating to the host network entity 110, such as CPU usage, memory usage, a number of TCP connections, a number of failed connection, etc. The agent 112 may also collect identifying or sensitive data related to the host network entity 110 such as client server names, host names, IP addresses, application names, application instance descriptive names, cluster names, descriptive cluster names, descriptive tier names, entity name, operating system, entity interface information, file system information, applications or processes installed or running, or disks that are mounted, or any data that reveals internal information about a customer or client and their network environment, as well as information that may be traditionally considered sensitive such as names, phone numbers, addresses, social security numbers, personal identification numbers, identification numbers, or other personal identification information that may be used in certain applications and stored by the management platform 120.

The collector module 140 is configured to handle the registration of the agents 112 with the management platform 120, receive collected data 114 from the agents 112, analyze the collected data 114, identify sensitive information in the data 114, extract the sensitive information, and store the data in either the data store 150 or sensitive data store 170. In some aspects, the collector module 140 may determine whether sensitive information is contained in the data 114 by using an algorithm. The algorithm may be configured to read the data 114, identify characters that signify identity information of the client or network entity 110, and remove the sensitive information from the data 114. By way of another example, the algorithm may utilize a list of attribute names (e.g., IPAddress, CustomerID, DestinationName, DestinationID, Topology, User) that are determined to contain or likely contain sensitive information. If data 114 includes an attribute name that is considered to contain sensitive information, the corresponding sensitive information is removed from the data 114. For example, the list of attribute names that are determined to contain sensitive information may include an attribute name of “IPAddress.” If data 114 includes an attribute name of “IPAddress,” then the corresponding sensitive information is removed from the data 114.

The sensitive information 144 extracted by the collector module 140 may be routed by the collector module 140 to the sensitive data store 170 for storage. The sensitive data store 170 may be a conventional relational database, other embodiments however, may utilize other types of databases (e.g., NoSQL, NewSQL, etc.).

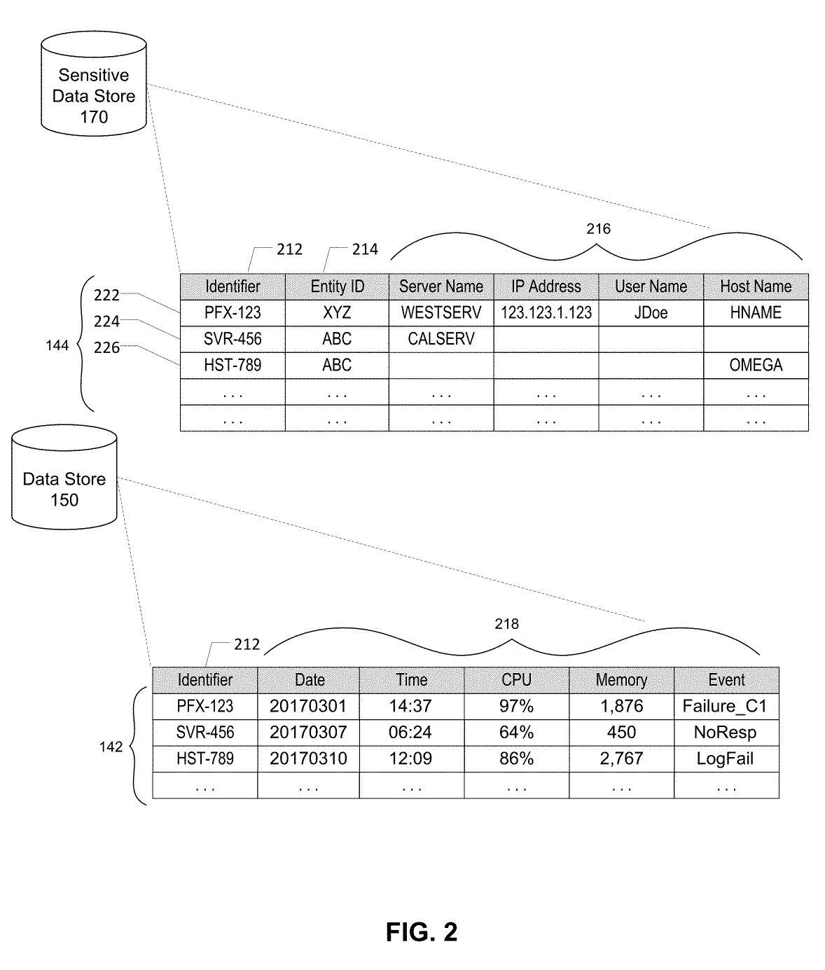

Referring to FIG. 2, the sensitive data store 170 is configured to store sensitive information 144 in a manner that allows a management platform (e.g., the management platform 120 of FIG. 1) to locate sensitive information associated with particular network entities. For example, the sensitive data store 170 may contain a multitude of entries, with each entry including an identifier 212, a network entity identifier 214, and sensitive data 216. The entity identifier 214 may comprise a name, a numerical value, a hash value, or any other data that may be used to identify a network entity. The identifier 212 may be a name, a label, code, or any other data that may be used to identify a record in the sensitive data store 170. In one aspect, the identifier 212 may comprise a three letter prefix and three number suffix. The prefix may indicate the type of sensitive data collected for a particular network entity and the suffix may represent a numerical identifier. In this example, the management platform may use the prefix in the identifier 212 to efficiently locate the record for the type of sensitive data 216 requested by the management platform. For example, record 224 uses an “SVR” prefix which may indicate that the corresponding data stored in record 224 represents a server name. In another example, record 226 uses an “HST” prefix which may indicate that the corresponding data stored in record 226 represents a host name.

Each record in the sensitive data store 170 may include one or more types of sensitive data 216 for a particular network entity. In some embodiments, sensitive data may be grouped based on the network entity from which the sensitive data was collected. In this example, sensitive data 216 (e.g., client server names, host names, IP addresses, application names, application instance descriptive names, cluster names, descriptive cluster names, descriptive tier names, entity name, operating system, entity interface information, file system information, applications or processes installed or running) collected from a particular network entity may be grouped together in a single record 222 and identified by a single identifier 212.

In other embodiments, each type of sensitive data 216 may be identified by a separate identifier 212. In this example, the sensitive data for a particular network entity may comprise multiple identifiers, with each identifier 212 being associated with a type of sensitive data (e.g., client server names, host names, IP addresses, application names, application instance descriptive names, cluster names, descriptive cluster names, descriptive tier names, entity name, operating system, entity interface information, file system information, applications or processes installed or running) collected from a particular network entity. For example, referring to FIG. 2, records 224 and 226 are associated with the same network entity “ABC” and provide different types of sensitive data 216. Record 224 identifies the server name for the “ABC” network entity and record 226 identifies the host name for the “ABC” network entity.

To access sensitive data for a particular network entity, the management platform may identify an entry for a particular network entity in the sensitive data store 170 using the entity identifier 214. Based on the entity identifier 214, the management platform may then determine the identifier 212 for the sensitive data 216 of a particular network entity for use with the data store 150, as described further below.

In one aspect, by storing the sensitive data 216 in the sensitive data store 170, the sensitive data 216 may be further encrypted by an encryption module 180 (shown in FIG. 1) to further protect and secure the sensitive data from inadvertent disclosure or compromise. In another aspect, the sensitive data 216 may be transformed into a standard format (e.g., canonical formats for data streams) prior to storing in the sensitive data store 170.

Referring back to FIG. 1, the collector module 140 may be further configured to replace the sensitive information in the collected data 114 with one or more identifiers thereby creating modified data 142. The modified data 142 may include metric data that comprises events, logs, metrics, transactions, alerts, entity performance, time-based data, CPU usage, memory usage or other telemetry records. The modified data 142 created by the collector module 140 may be routed by the collector module 140 to the data store 150 for storage. In one aspect, the modified data 142 may also be transformed into a standard format (e.g., canonical formats for data streams) and compressed prior to storing in the data store 150, to reduce file size. The data store 150 may be a conventional relational database, other embodiments however, may utilize other types of databases (e.g., NoSQL, NewSQL, etc.).

Referring back to FIG. 2, the data store 150 is configured to store the modified data 142 in a manner that allows a management platform (e.g., the management platform 120 of FIG. 1) to locate metric data associated with particular network entities. For example, data store 150 may contain a multitude of entries, with each entry including the identifier 212 and metric data 218. Each record in the data store 150 includes metric data 218 (e.g. events, logs, metrics, transactions, alerts, entity performance, time-based data, CPU usage, transaction bytes, transaction latency, memory usage or other telemetry records) for a particular network entity.

To access metric data for a particular network entity, the management platform queries the sensitive data store 170 using the desired entity identifier 214 for the selected network entity to identify the appropriate identifier 212 for the particular network entity. Using the identified identifier 212, the management platform queries the data store 150 to retrieve the appropriate metric data 218 for the particular network entity. In one aspect, by maintaining sensitive data 216 and metric data 218 in different data stores, the sensitive data 216 may be encrypted and protected from inadvertent disclosure, while allowing the non-sensitive metric data 218 to remain unencrypted and available for performance processing. In another aspect, by utilizing the identifier 212 as an index for both the sensitive data store 170 and data store 150, the identifier 212 facilitates efficient retrieval of sensitive data 216 and metric data 218 stored in each of the data stores, 170 and 150.

In another aspect, the metric data 218 may be searched using one or more types of metric data 218 stored in the data store 150. For example, the management platform may be configured for keyword or text searching of metric data 218 that comprises textual or non-numeric data points, such as metric data associated with events, logs (e.g., log entry, host inventory, process status, server startup, service terminate, etc.), or alerts (e.g., a warning that a threshold has been reached, something has changed, or a failure has occurred).

Referring back to FIG. 1, the data store 150 may also include historical performance data associated with the network entities or metrics calculated based on historical data. The modified data 142 may be queried, analyzed, or further processed by an analyzer module 160 to yield a result. The result may comprise performance metrics relating to the network entities 110 that is created using the modified data 142. For example, the analyzer module 160 may be configured to create native aggregation, baselines, or histograms using the modified data 142. As another example, the analyzer module 160 may be configured to correlate data from multiple network entities 110 to identify trends and may be further configured to generate alerts based on the trends. In one aspect, because the sensitive information 144 is removed from the collected data 114, analysis of the modified data 142 stored in the data store 150 may be performed more efficiently due to not only the reduced size of the data stored in the data store 150, but also due to analysis and querying of data not requiring encryption and decryption, as encrypted data cannot be queried or searched. In addition, because the data store 150 does not contain sensitive information, there is no need to encrypt the data stored in the data store 150.

In one aspect, the result created by the analyzer module 160 may include the identifier associated with a particular network entity 110. The collector module 140 may read the identifier contained in the result and perform a lookup or query function using the identifier in the result to locate the appropriate record of sensitive information 144 stored in the sensitive data store 170. Upon locating the appropriate record in the sensitive data store 170 using the identifier, the collector module 140 may replace the identifier in the result with the sensitive information 144 associated with that identifier to thereby create a modified result 116 containing the sensitive information. The modified result 116 containing the sensitive information 144 may thereafter be presented for display to users of the management platform 120 via the user interface module 190.

The user interface module 190 may be configured to receive input from users of the management platform 120. For example, the user interface 190 may be configured to receive user data for the network entities 110. The user data may include sensitive information (e.g., IP addresses, host names, geographic locations, departments, functions, or other user data). The user interface 190 may also be configured to collect the user data and route the collected data to the collector module 140. The user interface 190 may further be configured to present or display performance metrics (e.g. the modified result 116) to a user or client. In some aspects, the management platform 120 may evaluate whether the user or client has the proper authorization to view the sensitive information 144 before presenting the sensitive information 144 to the user or client through the user interface 190.

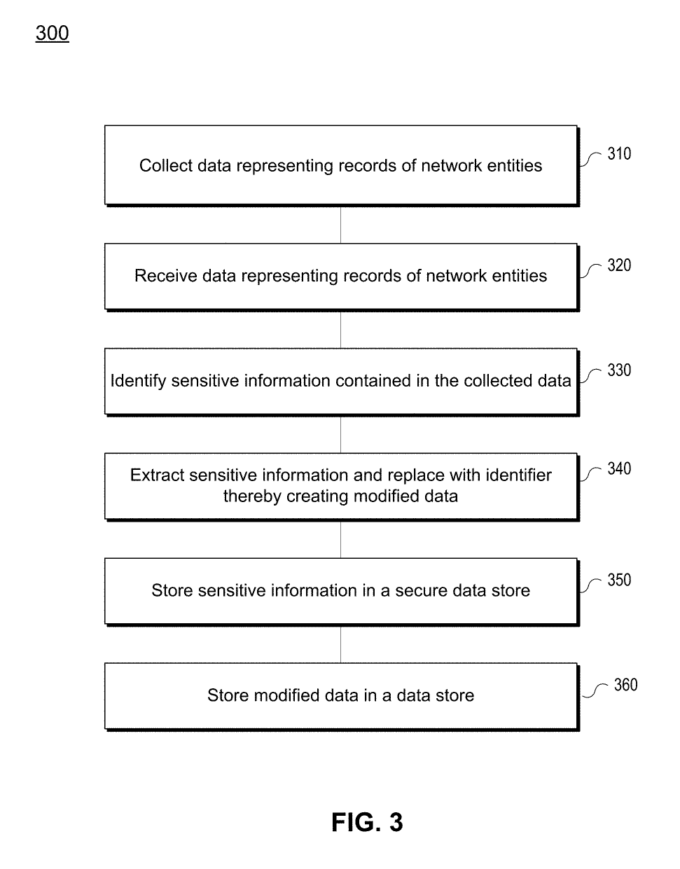

FIG. 3 shows an example method 300 for managing sensitive data in a network environment, in accordance with various aspects of the subject technology. It should be understood that, for any process discussed herein, there can be additional, fewer, or alternative steps performed in similar or alternative orders, or in parallel, within the scope of the various embodiments unless otherwise stated. The process 300 can be performed by a network, and particularly, a management system (e.g., the management platform 120 of FIG. 1) or similar system.

At operation 310, the system may collect data that represents performance information or records of network entities in the network. The records may be created or updated based on the data received from a network entity or user interface. The data may include various attributes of certain network entities. The attributes may include, for example, client server names, host names, IP addresses, application names, application instance descriptive names, cluster names, descriptive cluster names, descriptive tier names, entity name, operating system, entity interface information, file system information, applications or processes installed or running, or disks that are mounted, or any other data that may be used to identify one or more network entities, as well as personal identification information that may be used in certain applications and stored by the management platform such as names, phone numbers, addresses, social security numbers, personal identification numbers, or identification numbers.

The records may further be created, updated, or supplemented with information observed by agents and reported to the management system by the agents. This information may include events, logs, metrics, transactions, alerts, entity performance, CPU usage, memory usage, other telemetry records, or other time series data.

At operation 320, the system receives the data via a collector module. The data may be received from a network entity, agent, application, or user via a user interface or through another party or service via an application program interface (API).

The system may review the data and identify sensitive information contained in the data at operation 330. For example, the system may process the data via the collector module to identify sensitive information contained in the collected data. The collector module may use an algorithm to identify the sensitive information by reading the data to identify characters that signify identity information of the network entity. By way of another example, the algorithm may utilize a list of attribute names that are determined to contain or likely contain sensitive information. If the data includes an attribute name that is considered to contain sensitive information, the corresponding sensitive information is removed. For example, the list of attribute names that are determined to contain sensitive information may include an attribute name of “IPAddress.” If the data includes an attribute name of “IPAddress,” then the corresponding sensitive information is removed from the data.

At operation 340, the system extracts the sensitive information and replaces the sensitive information with one or more identifiers thereby creating modified data. For example, the system may extract the sensitive information using the collector module. The collector module may further replace the extracted sensitive information with the identifier thereby creating modified data. The identifier may facilitate later retrieval of the sensitive information by having a number, code, or label assigned to the sensitive information. The identifier may later be used to identify the specific sensitive information removed from the data. The identifier may further include information identifying the type of information the sensitive information represents. For example, if the sensitive information represents a client server name, the identifier may have a prefix indicating that the removed or scrubbed sensitive information represents a client server name.

The system may then store the sensitive information in a secure data store for encryption at operation 350. For example, the collector module may route the sensitive information to the secure data store. At operation 360, the modified data is stored in a separate data store for analysis. For example, the collector module may route the modified data to the data store for storage and further analysis by an analysis module. The data store may also include historical performance data associated with network entities or metrics calculated based on historical data. The modified data may be queried, analyzed, or further processed by the analyzer module.

According to various embodiments of the disclosure, because the sensitive information is removed from the data, analysis of the modified data stored in the data store may be performed more efficiently due to not only the reduced size of the data stored in the data store, but also due to analysis and querying of data not requiring encryption and decryption. In addition, because the data store does not contain sensitive information, there is no need to encrypt the data stored in the data store.

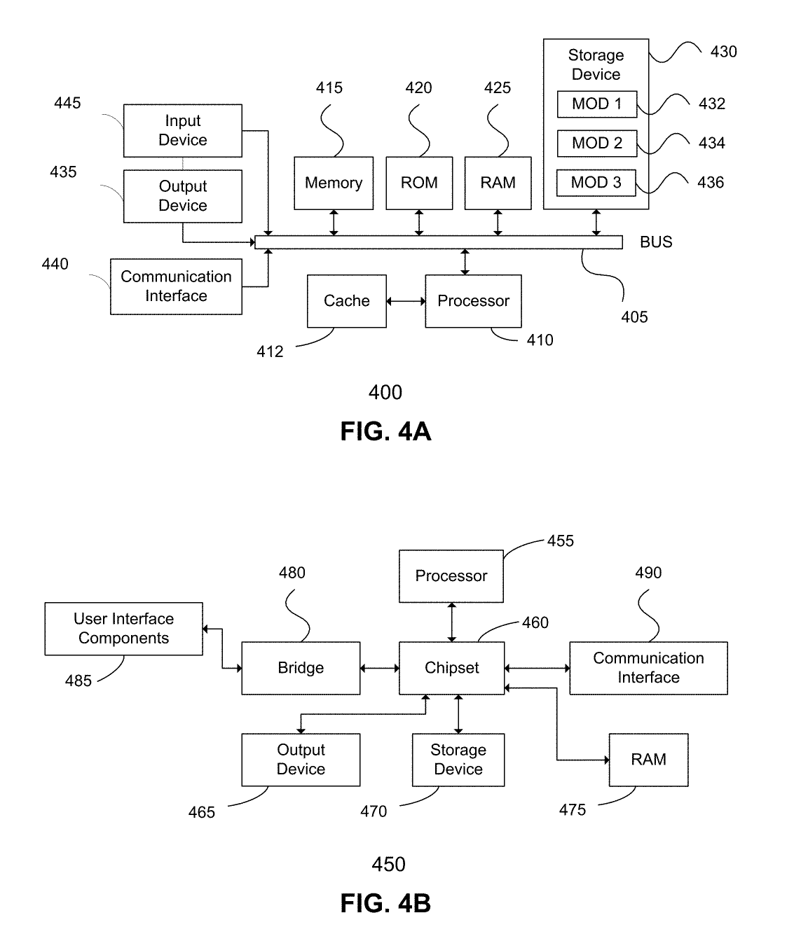

FIG. 4A and FIG. 4B illustrate systems in accordance with various embodiments. The more appropriate system will be apparent to those of ordinary skill in the art when practicing the various embodiments. Persons of ordinary skill in the art will also readily appreciate that other systems are possible.

FIG. 4A illustrates an example architecture for a conventional bus computing system 400 wherein the components of the system are in electrical communication with each other using a bus 405. The computing system 400 can include a processing unit (CPU or processor) 410 and a system bus 405 that may couple various system components including the system memory 415, such as read only memory (ROM) in a storage device 420 and random access memory (RAM) 425, to the processor 410. The computing system 400 can include a cache 412 of high-speed memory connected directly with, in close proximity to, or integrated as part of the processor 410. The computing system 400 can copy data from the memory 415 and/or the storage device 430 to the cache 412 for quick access by the processor 410. In this way, the cache 412 can provide a performance boost that avoids processor delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 432, module 2 434, and module 3 436 stored in storage device 430, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing system 400, an input device 445 can represent any number of input mechanisms, such as a microphone for speech, a touch-protected screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing system 400. The communications interface 440 can govern and manage the user input and system output. There may be no restriction on operating on any particular hardware arrangement and therefore the basic features here may easily be substituted for improved hardware or firmware arrangements as they are developed.

Storage device 430 can be a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 430 can include software modules 432, 434, 436 for controlling the processor 410. Other hardware or software modules are contemplated. The storage device 430 can be connected to the system bus 405. In one aspect, a hardware module that performs a particular function can include the software component stored in a computer-readable medium in connection with the necessary hardware components, such as the processor 410, bus 405, output device 435, and so forth, to carry out the function.

FIG. 4B illustrates an example architecture for a conventional chipset computing system 450 that can be used in accordance with an embodiment. The computing system 450 can include a processor 455, representative of any number of physically and/or logically distinct resources capable of executing software, firmware, and hardware configured to perform identified computations. The processor 455 can communicate with a chipset 460 that can control input to and output from the processor 455. In this example, the chipset 460 can output information to an output device 465, such as a display, and can read and write information to storage device 470, which can include magnetic media, and solid state media, for example. The chipset 460 can also read data from and write data to RAM 475. A bridge 480 for interfacing with a variety of user interface components 485 can be provided for interfacing with the chipset 460. The user interface components 485 can include a keyboard, a microphone, touch detection and processing circuitry, a pointing device, such as a mouse, and so on. Inputs to the computing system 450 can come from any of a variety of sources, machine generated and/or human generated.

The chipset 460 can also interface with one or more communication interfaces 490 that can have different physical interfaces. The communication interfaces 490 can include interfaces for wired and wireless LANs, for broadband wireless networks, as well as personal area networks. Some applications of the methods for generating, displaying, and using the GUI disclosed herein can include receiving ordered datasets over the physical interface or be generated by the machine itself by processor 455 analyzing data stored in the storage device 470 or the RAM 475. Further, the computing system 400 can receive inputs from a user via the user interface components 485 and execute appropriate functions, such as browsing functions by interpreting these inputs using the processor 455.

It will be appreciated that computing systems 400 and 450 can have more than one processor 410 and 455, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method, comprising:
receiving first data from a network entity, the first data comprising information about the network entity;
identifying sensitive information contained in the first data;
extracting the sensitive information from the first data;
storing the sensitive information in a first data store;
replacing the sensitive information in the first data with an identifier to create second data; and
storing the second data in a second data store.

2. The computer-implemented method of claim 1, further comprising encrypting the sensitive information stored in the first data store.

3. The computer-implemented method of claim 1, further comprising analyzing the second data store to yield a first result, the first result containing the identifier.

4. The computer-implemented method of claim 3, further comprising locating and retrieving the sensitive information stored in the first data store using the identifier in the first result.

5. The computer-implemented method of claim 4, further comprising replacing the identifier in the first result with the sensitive information stored in the first data store to yield a second result.

6. The computer-implemented method of claim 1, wherein the identifier corresponds to an attribute associated with the network entity.

7. The computer-implemented method of claim 1, wherein the sensitive information comprises one of an IP address, MAC address, server name, host name, or application name.

8. A non-transitory computer-readable medium comprising instructions, the instructions, when executed by a computing system, cause the computing system to:
receive data relating to a network entity;
identify information in the data relating to an identity of the network entity;
extract the identifying information from the data;
store the identifying information in a first data store;
replace the identifying information in the data with an identifier to create modified data; and
store the modified data in a second data store.

9. The non-transitory computer-readable medium of claim 8, wherein the instructions further cause the computing system to encrypt the identifying information stored in the first data store.

10. The non-transitory computer-readable medium of claim 8, wherein the instructions further cause the computing system to analyze the modified data yielding a result, the result containing the identifier.

11. The non-transitory computer-readable medium of claim 10, wherein the instructions further cause the computing system to retrieve the identifying information from the first data store using the identifier in the result.

12. The non-transitory computer-readable medium of claim 11, wherein the instructions further cause the computing system to replace the identifier in the result with the retrieved identifying information thereby yielding a modified result.

13. The non-transitory computer-readable medium of claim 8, wherein the identifier corresponds to an attribute associated with the network entity.

14. The non-transitory computer-readable medium of claim 8, wherein the identifier comprises a unique identifier and an attribute associated with the network entity.

15. The non-transitory computer-readable medium of claim 8, wherein the identifying information comprises one of an IP address, MAC address, server name, host name, or application name.

16. A system comprising:
a processor; and
a non-transitory computer-readable medium storing instructions that, when executed by the system, cause the system to:
identify information in data received from a network entity relating to an identity of the network entity;
extract the identity information from the data;
store the identity information in a first data store;
replace the identity information in the data with an identifier to create modified data; and
store the modified data in a second data store.

17. The system of claim 16, wherein the instructions further cause the system to encrypt the identity information stored in the first data store.

18. The system of claim 16, wherein the instructions further cause the system to analyze the modified data yielding a result, the result containing the identifier.

19. The system of claim 18, wherein the instructions further cause the system to retrieve the identity information from the first data store using the identifier in the result.

20. The system of claim 19, wherein the instructions further cause the system to replace the identifier in the result with the retrieved identity information thereby yielding a modified result.
